(19) United States
(12) Patent Application Publication
(10) Pub. No.: US 2013/0136328 A1
(43) Pub. Date: May 30, 2013

(54) METHODS AND SYSTEMS FOR ENHANCED TOMOGRAPHIC IMAGING

(71) Applicants: Floribertus Heukensfeldt Jansen, Ballston Lake, NY (US); Ravindra Mohan Manjeshwar, Glenville, NY (US)

(72) Inventors: Floribertus Heukensfeldt Jansen, Ballston Lake, NY (US); Ravindra Mohan Manjeshwar, Glenville, NY (US)

(73) Assignee: GENERAL ELECTRIC COMPANY, SCHENECTADY, NY (US)

(21) Appl. No.: 13/307,753

(22) Filed: Nov. 30, 2011

(51) Int. Cl. G06K 9/00

(52) U.S. Cl. 382/131

(57) ABSTRACT

Nuclear imaging systems, non-transitory computer readable media and methods for tomographic imaging are presented. Projection data is acquired by scanning one or more views of a subject for a designated scan interval less than a total scan interval. A first image of a target region of interest (ROI) is reconstructed using projection data acquired over a first fraction of the designated scan interval. A second target ROI image is reconstructed using at least a subset of projection data acquired over the first and/or a second fraction. A change in an image quality characteristic over the first and the second fractions is determined by determining one or more differences between the first and the second images. A value of an imaging parameter is estimated based on the change to acquire projection data for generating a target ROI image having at least a predetermined level of the image quality characteristic.

### BACKGROUND

Non-invasive imaging techniques are widely used in security screening, quality control, and medical diagnostic systems. Particularly, in medical imaging, non-invasive imaging techniques such as multi-energy imaging allow for unobtrusive, convenient and fast imaging of underlying tissues and organs. To that end, radiographic imaging systems such as nuclear medicine (NM) gamma cameras, computed tomography (CT) systems, single photon emission CT (SPECT) systems and positron emission tomography (PET) systems generate images that illustrate various biological processes and functions for medical diagnoses and treatment.

PET systems, for example, generate images that represent a distribution of positron-emitting nuclides within a patient's body. Typically, a positron-electron interaction results in annihilation, thus converting entire mass of the positron-electron pair into two 511 kilo-electron volt (keV) photons emitted in opposite directions along a line of response. In a PET system, detectors placed along the line of response on a detector ring detect the annihilation photons. Particularly, the detectors detect a coincidence event if the photons arrive and are detected at the detector elements at the same time. The PET system uses the detected coincidence information along with other acquired image data for generating the PET images.

Typically, the quality of the PET images depends on image statistics, which in turn are closely related to detected coincidence events. The image statistics, for example, may be improved by acquiring the image data for longer durations. However, the total scan time for acquiring the image data is limited by the decay of a radioactive isotope used in imaging and by the inability of the patients to remain immobile for extended durations. Further, patient size, attenuation, physiology, injected dose and spatial distribution of the detected radiation events affect image quality, often resulting in inadequate signal-to-noise ratio (SNR) at the region of interest (ROI). Use of a fixed scan time or detection of a fixed number of coincidence events, thus, does not guarantee acquisition of sufficient data for reconstructing a PET or SPECT image of the ROI at a desired SNR.

Accordingly, certain imaging systems estimate noise in reconstructed images to account for the uncertainty at the ROI in the reconstructed images. Accurate error estimation provides a clinician with confidence levels for evaluating biological parameters precisely, such as, for standardized uptake values (SUV) quantification in oncology applications. Certain imaging systems, for example, employ Poisson noise in the projections for reconstructing images using filtered back-projection or iterative reconstruction. The imaging systems, however, may ignore “noise” sources introduced by processing steps such as scatter correction and interpolation, thus leading to inaccuracies during image reconstruction. Furthermore, such analytical approaches to error estimation are often application-specific and are suitable for only a small subset of imaging configurations.

### BRIEF DESCRIPTION

Certain aspects of the present technique are drawn to a method for tomographic imaging. Projection data is acquired by scanning one or more views of a subject for a designated scan interval, where the designated scan interval is less than a total scan interval. A first image of a target region of interest of the subject is reconstructed using projection data acquired over a first fraction of the designated scan interval. Additionally, a second image of the target region of interest is reconstructed using at least a subset of projection data acquired over the first fraction of the designated scan interval and/or a second fraction of the designated scan interval. Further, a change in an image quality characteristic over the first and the second fractions of the designated scan interval is determined by determining one or more differences between the first image and the second image. A value of an imaging parameter is then estimated based on the change in the image quality characteristic over the first and the second fractions of the designated scan interval to acquire projection data for generating an image of the target region of interest having at least a predetermined level of the image quality characteristic.

A further aspect of the present technique corresponds to a tomographic imaging method using synthetic projection of the target region of interest. Certain other aspects of the present technique correspond to non-transitory computer readable media and nuclear medicine imaging systems used to implement the present method as described herein.

### DRAWINGS

These and other features and aspects of embodiments of the present technique will become better understood when the following detailed description is read with reference to the accompanying drawings in which like characters represent like parts throughout the drawings, wherein:

FIG. 1 is a pictorial view of an exemplary imaging system for enhanced tomographic imaging;

FIG. 2 is a diagrammatic illustration of exemplary components of an exemplary PET system using bootstrapped image reconstruction for enhanced tomographic imaging, in accordance with aspects of the present technique;

FIG. 3 is a flowchart depicting an exemplary method for enhanced tomographic imaging using bootstrapped image reconstruction, in accordance with aspects of the present technique; and

FIG. 4 is a graphical representation of an exemplary noise versus time curve for use in estimating a change in an image quality characteristic over different fractions of a designated scan interval, in accordance with aspects of the present technique; and

FIG. 5 is a flowchart depicting an exemplary method for enhanced tomographic imaging using bootstrapped image reconstruction, in accordance with aspects of the present technique.

### DETAILED DESCRIPTION

The following description presents exemplary systems and methods for enhanced tomographic imaging. Particularly, embodiments illustrated hereinafter disclose imaging systems and methods that aim to estimate uncertainty in a reconstructed image using a “bootstrap” approach, and use the estimated uncertainty to optimize image data acquisition for reconstructing images of a targeted region of interest (ROI) with a desired spatial resolution.

In the bootstrap approach, a single data set is used to determine a statistical distribution of an estimated statistic θ, for example, a pixel value in a reconstructed image. To that end, multiple bootstrap replicates are generated from the original data set by randomly drawing samples from the original data set. Each bootstrap replicate is then treated as an independent measurement from which θ can be determined Particularly, a resulting variance in θ determined using the bootstrap replicates generated from a fraction of the original data set can be used to estimate the variance in θ that would typically be determined from multiple independent data sets.

Although exemplary embodiments of the present technique are described in the context of a PET system employing bootstrapped image reconstruction, it will be appreciated that use of the present technique in various other imaging applications and systems is also contemplated. Some of these systems may include computed tomography systems, SPECT scanners, single or multiple detector imaging systems, X-ray tomosynthesis devices, microscopes, digital cameras and/or charge-coupled devices that acquire projection data from multiple view angles.

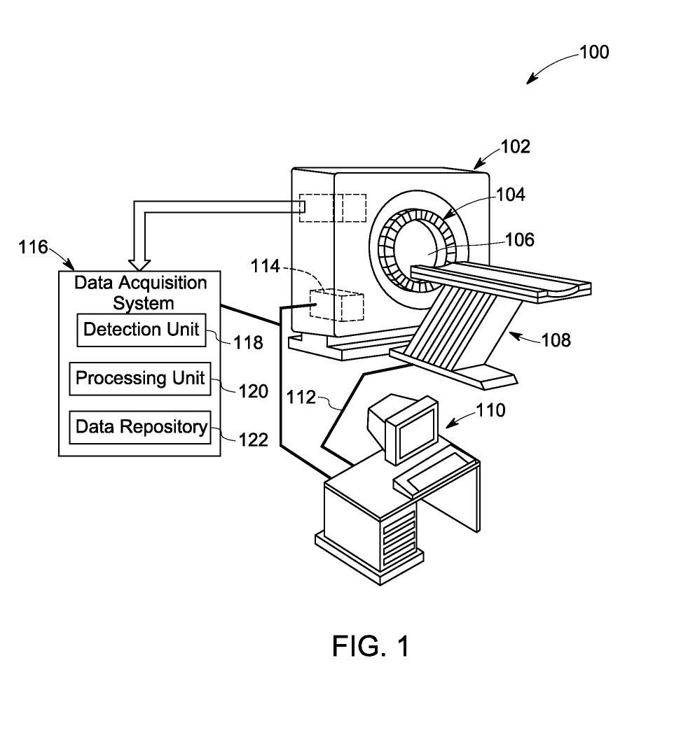

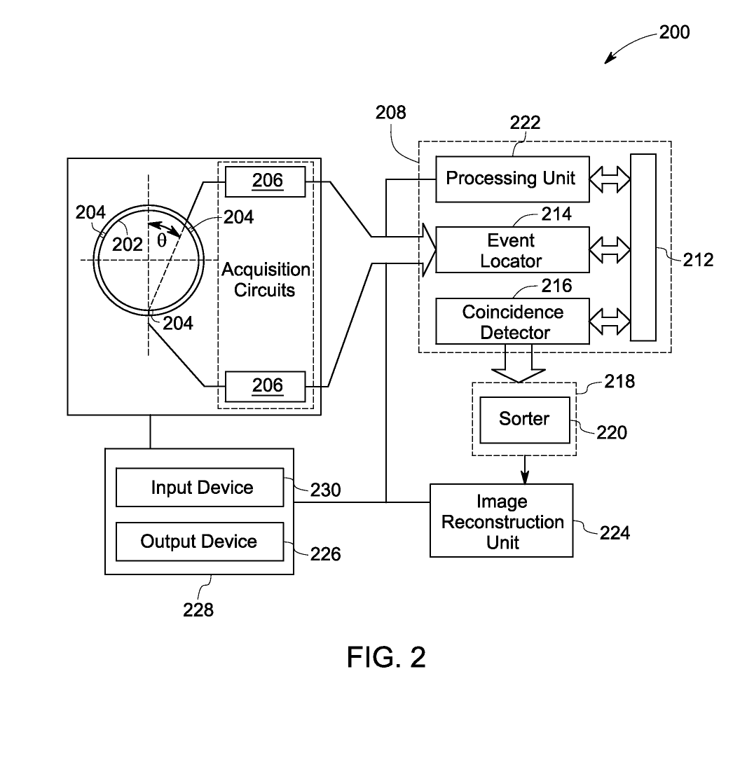

Further, in addition to medical imaging, the techniques and configurations discussed herein can be used in pharmacological and pre-clinical research for the development and evaluation of innovative tracer compounds. Further, certain stationary SPECT systems, for example, General Electric Company's Discovery 530c SPECT system can employ the present technique for noise estimation and enhanced tomographic image reconstruction of a lesion or a small region of the subject such as heart or pancreas. An exemplary environment that is suitable for practicing various implementations of the present technique is discussed in the following sections with reference to FIGS. 1-2.

FIG. 1 illustrates an exemplary nuclear imaging system 100 for acquiring and processing projection data. In one embodiment, the imaging system 100 corresponds to a PET system. In alternative embodiments, however, the system 100 may include other imaging modalities such a SPECT system or a hybrid imaging system. The hybrid imaging system, for example, includes a PET/CT or SPECT/CT scanner operable to provide emission and transmission data corresponding to PET, CT and/or SPECT images.

Accordingly, in certain embodiments, the system 100 includes a gantry 102, which supports a detector ring assembly 104 about a central axis or bore 106. Further, the system 100 includes a patient table 108 positioned in front of the gantry 102, and aligned with the central axis of the bore 106. Additionally, the system 100 includes a table controller (not shown) that moves the table 108 into the bore 106 in response to commands, for example, received from an operator workstation 110 through a communications link 112. The system 100, in one embodiment, also includes a gantry controller 114 that operates the gantry 102 in response to commands received from the operator workstation 110. Particularly, the gantry controller 114 suitably positions the gantry 102 to operate in different modes, for example two-dimensional (2D) or three-dimensional (3D) modes, and/or perform various types of scans for acquiring sufficient data for image reconstruction.

Further, the system 100 also includes a data acquisition system (DAS) 116 for acquiring and processing radiation events. To that end, the DAS 116 includes a detection unit 118 and a processing unit 120 for detecting individual radiation events data and identifying coincidence events based on corresponding timestamps. In certain embodiments, the processing unit 120 stores the data associated with the identified coincidence events, for example, in chronological order in a data repository 122. The processing unit 120 then uses the chronological list of coincidence data to reconstruct PET scan images for display and diagnosis.

In certain embodiments, the processing unit 120 estimates a measure of uncertainty in the reconstructed image using “bootstrapping.” To that end, the processing unit 120 uses a fraction of the detected radiation events to reconstruct an image. Further, the processing unit 120 repeats image reconstruction using a different random fraction of the detected events. The processing unit 120 then determines one or more differences between the images reconstructed using different fractions of detected radiation events. The determined differences provide a good estimate of the uncertainty in the image, and thus, can be used to set stopping criteria for image data acquisition.

Particularly, in one embodiment, the processing unit 120 uses the determined differences to estimate an expected time for generating an image having one or more desired image quality characteristics for use, for example, in detecting even small lesions with accuracy. To that end, the image quality characteristics, for example, include spatial resolution, signal energy, SNR, contrast-to-noise ratio (CNR), contrast recovery, lesion bias, detectability, or a combination of signal energy, signal contrast and image noise.

Furthermore, in certain embodiments, the processing unit 120 provides visual indication of how additional imaging time will affect image quality on an output device, for example, a monitor associated with the operator workstation 110. The operator can use the time and quality projections to determine when and whether to continue or terminate a scan, thus, enhancing data acquisition. Certain exemplary components of a nuclear imaging system used in implementing the present bootstrapped image reconstruction technique for enhanced image reconstruction will be described in greater detail with reference to FIG. 2.

FIG. 2 illustrates another embodiment of an exemplary nuclear imaging system 200, similar to the system 100 illustrated in FIG. 1. Particularly, FIG. 2 illustrates certain exemplary components of the system 200 for use in implementing the present technique for enhancing nuclear tomographic imaging. To that end, the system 200 includes a detector ring assembly 202 disposed about a patient bore. The detector ring assembly 202 may include multiple detector rings that are spaced along the central axis to form the detector ring assembly 202. The detector rings, in turn, are formed of detector modules 204 that include, for example, a 6 by 6 array of individual bismuth germanate (BGO) detector crystals. The detector crystals detect gamma radiation emitted from a patient, and in response, produce photons.

In one embodiment, the array of detector crystals is positioned in front of a plurality of photomultiplier tubes (PMTs). The PMTs produce analog signals when a scintillation event occurs at one of the detector crystals, for example, when a gamma ray emitted from the patient is received by one of the detector crystals. Further, a set of acquisition circuits 206 in the system 200 receive the analog signals and generate corresponding digital signals indicative of the location and the energy associated with the detected radiation event.

In one embodiment, the system 200 includes a DAS 208 that periodically samples the digital signals produced by the acquisition circuits 206. To that end, the DAS 208 includes a processing unit 222, which controls communications on the local area network 210 and a backplane bus 212. Additionally, the DAS 208 also includes event locator circuits 214 that assemble information corresponding to each valid radiation event into an event data packet. The even data packet, for example, includes a set of digital numbers that precisely indicate the time of the radiation event and the position of the detector crystal that detected the event.

Further, the event locator circuits 214 communicate the assembled event data packets to a coincidence detector 216 for determining coincidence events. The coincidence detector 216 determines coincidence event pairs if time and location markers in two event data packets are within certain designated thresholds. In one embodiment, the coincidence detector 216 determines a coincidence event pair if time markers in two event data packets are, for example, within 12.5 nanoseconds of each other and if the corresponding locations lie on a straight line passing through the field of view (FOV) in the patient bore.

In certain embodiments, the system 200 stores the determined coincidence event pairs in a storage subsystem 218 operatively coupled to the system 200. The storage subsystem 218, in one embodiment, includes a sorter 220 to sort the coincidence events in a 3D projection plane format, for example, using a look-up table. Particularly, the sorter 220 orders the detected coincidence event data using one or more parameters such as radius or projection angles for storage. In one embodiment, the processing unit 222 processes the stored data to determine time-of-flight (TOF) information. The TOF information allows the system 200 to estimate a point of origin of the electron-positron annihilation with greater accuracy, thus improving event localization. An image reconstruction unit 224 communicatively coupled to the system 200 uses the event localization data to generate images of a region of interest (ROI) of a patient for further clinical evaluation.

Particularly, the system 200 uses values of one or more parameters such as noise or contrast ratio derived from the reconstructed images to detect a type and extent of a diseased condition of the patient with a desired level of confidence. In a heart examination, for example, accurate identification of ischemia using image-derived parameters such as reconstructed intensity values may require the uncertainty in the image of the target ROI to be less than 10 percent. Accordingly, a PET system operator may configure the system 200 to scan the target ROI for about 20 minutes, for example, based on prior exam data.

However, patient size, physiology and spatial distribution of the injected dose in the patient's body may affect image quality. Furthermore, use of a fixed scan time or detection of a fixed number of coincidence events may not guarantee acquisition of sufficient data for reconstructing the ROI having desired image quality characteristics. Accordingly, a PET system operator may be unable to estimate an expected time for completion of desired data acquisition accurately, and thus, may require additional PET scans for acquiring sufficient data for high quality reconstruction of the ROI images. The repeated PET scans in such scenarios, however, may result in additional dosage and longer scanning times, which in turn add to patient discomfort. Additionally, patient motion and redistribution of the injected dose in the patient's body during a subsequent scan makes it difficult to register the original image with the one acquired at a later point of time.

Accordingly, instead of employing additional PET scans, the system 200 uses a bootstrap approach for efficiently estimating an image quality characteristic in the reconstructed images to account for the uncertainty at the ROI. To that end, the processing unit 222 configures the system 200 to reconstruct one or more preliminary images using projection data acquired over a first fraction of the total scan interval. The processing unit 222, for example, employs rapid scanning protocols to allow the system 200 to obtain data from a designated set of view angles in the first fraction of the total scan interval for generating a complete ROI image. Alternatively, in one embodiment, the system 200 employs imaging systems, for example, using General Electric Company's Alcyone™ technology to acquire sufficient projection data from all view angles for reconstructing a first set of images of the ROI.

In certain embodiments, the processing unit 222 configures the system 200 to acquire radiation events detected over a second fraction of the total scan time. Additionally, the processing unit 222 configures the image reconstruction unit 224 to reconstruct a second set of one or more images using a subset of radiation events selected randomly from the total number of events acquired over the first and second fraction of the total scan interval. Further, the processing unit 222 compares the first and the second set of images to ascertain one or more differences between the images reconstructed using different fractions of detected radiation events.

In one embodiment, the ascertained differences provide a good estimate of the uncertainty or noise in the images. Accordingly, the processing unit 222 uses the change in the estimated noise over time to indicate a current value of an image quality characteristic of interest in an image reconstructed using the projection data acquired so far. Additionally, the processing unit 222 estimates a further scan interval that would allow the system 200 to acquire sufficient projection data for generating an image of the target ROI having at least a predetermined level of the image quality characteristic.

In certain embodiments, the processing unit 222 communicates the current and predicted image quality on an output device 226, such as a display, an audio and/or a video device coupled to the system 200. Communicating the current and predicted image quality allows the operator to terminate the scan using an input device 230 if a desired quality of the ROI image can be achieved using acquired information. Alternatively, the operator may continue scanning to acquire additional radiation events that allow reconstruction of ROI images of the desired quality.

It may be noted that the specific arrangements depicted in FIGS. 1-2 are exemplary. Further, the systems 100 and 200 may be configured or customized for additional functionality, different imaging applications and scanning protocols. Accordingly, in certain embodiments, the systems 100 and/or 200 are coupled to multiple displays, printers, workstations, and/or similar devices located either locally or remotely, for example, within an institution or hospital, or in an entirely different location via one or more configurable wired and/or wireless networks such as the Internet, cloud computing and virtual private networks.

In one embodiment, for example, the systems 100, 200 include, or are coupled to, a picture archiving and communications system (PACS). Particularly, in one exemplary implementation, the PACS is further coupled to a remote system, radiology department information system, hospital information system and/or to an internal or external network to allow operators at different locations to supply commands and parameters and/or gain access to the image data.

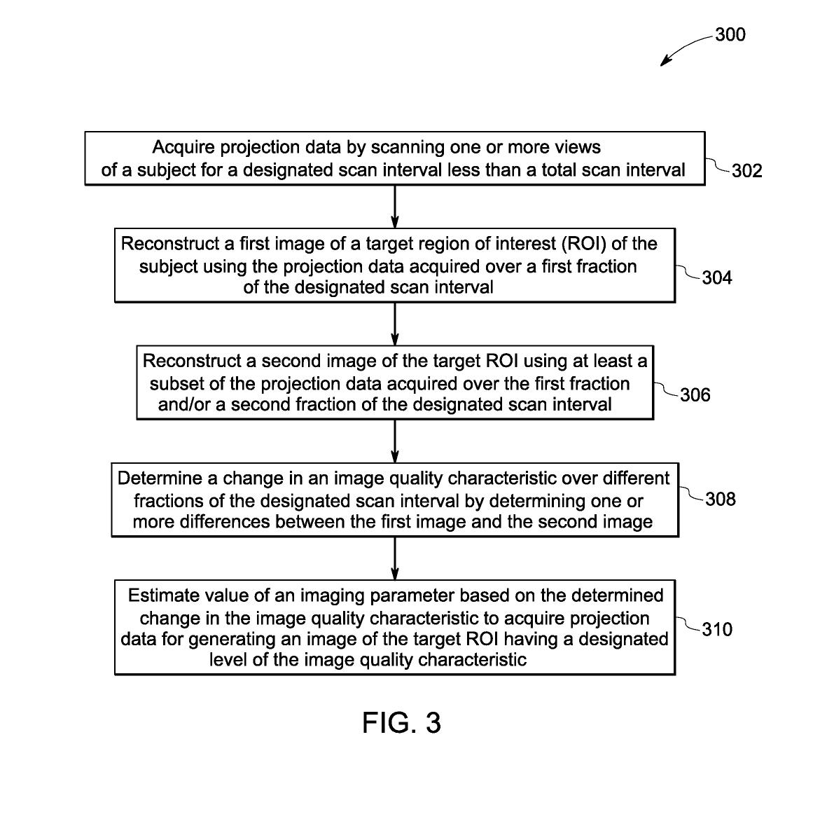

Embodiments of the present system 200, thus, use bootstrapped reconstruction to estimate the change in one or more image quality characteristics, such as noise in the reconstructed images over different fractions of the total scan interval. According to certain aspects of the present technique, bootstrapping provides the system 200 and/or the system operator with greater confidence levels for estimating appropriate imaging parameters such as view angles, radiation event counts, or scan durations for acquiring sufficient information to generate ROI images of a desired quality. Certain exemplary methods for improving tomographic imaging using bootstrapped image reconstruction will be described in greater detail with reference to FIG. 3.

FIG. 3 illustrates a flow chart 300 depicting an exemplary method for improved tomographic imaging using a bootstrap approach. The exemplary method may be described in a general context of computer executable instructions stored and/or executed on a computing system or a processor. Generally, computer executable instructions may include routines, programs, objects, components, data structures, procedures, modules, functions, and the like that perform particular functions or implement particular abstract data types. The exemplary method may also be practiced in a distributed computing environment where optimization functions are performed by remote processing devices that are linked through a wired and/or wireless communication network. In the distributed computing environment, the computer executable instructions may be located in both local and remote computer storage media, including memory storage devices.

Further, in FIG. 3, the exemplary method is illustrated as a collection of blocks in a logical flow chart, which represents operations that may be implemented in hardware, software, or combinations thereof. The various operations are depicted in the blocks to illustrate the functions that are performed, for example, during data acquisition, noise estimation and bootstrapped image reconstruction phases of the exemplary method. In the context of software, the blocks represent computer instructions that, when executed by one or more processing subsystems, perform the recited operations.

The order in which the exemplary method is described is not intended to be construed as a limitation, and any number of the described blocks may be combined in any order to implement the exemplary method disclosed herein, or an equivalent alternative method. Additionally, certain blocks may be deleted from the exemplary method or augmented by additional blocks with added functionality without departing from the spirit and scope of the subject matter described herein. For discussion purposes, the exemplary method will be described with reference to the elements of FIGS. 1-2.

Generally, tomographic imaging such as PET or SPECT imaging is used to generate 2D or 3D images for various diagnostic and/or prognostic purposes. Conventional imaging techniques allow for a tradeoff between various imaging criteria such as image quality, spatial resolution, noise, radiation dose and total scanning time. Certain clinical applications, however, entail use of images with high spatial resolution or CNR for investigating minute features within a subject, such as in and around a human heart. Particularly, clinical decisions regarding diagnosis and treatment of detected disease conditions are made based on certain image-derived parameters.

In one example, an image quality characteristic such as standard uptake value (SUV) derived from the tomographic images is used to determine malignancy of a tumor. The tumor may be considered malignant, for example, when the SUV reaches a designated critical value. In another example, the reconstructed images allow estimation of an uptake of an imaging tracer in a target ROI, such as the heart region of a patient. Ischemia of a region of the heart, for example, is identified when the estimated uptake of the imaging tracer in the ROI is lower than the average uptake in the rest of the heart tissue by a certain amount.

Accurate characterization of specific features corresponding to the thoracic cavity, thus, allows for a better understanding of the physiology of heart and lungs, which in turn aids in early detection of various cardiovascular and lung diseases. Inaccurate estimations of clinically relevant parameters such as the SUV and the degree of ischemia for a particular ROI, however, may lead to incorrect diagnosis, which in turn may adversely affect patient health. Accordingly, it is important for a clinician to know whether values computed from the reconstructed image can be trusted.

Accordingly, embodiments of the present method describe a bootstrapped image reconstruction technique for enhanced tomographic imaging. For discussion purposes, an embodiment of the present method will be described with reference to a nuclear imaging technique for improving image data acquisition by accurately estimating variations in image noise over different scan times using bootstrapped image reconstruction of a target ROI.

At step 302, an imaging system such as the system 200 of FIG. 2 acquires projection data from one or more views of a subject for a designated scan interval that is typically less than a total scan interval. In one embodiment, the system 200 configures a length of the designated scan interval in relation to the total scan interval for acquiring sufficient projection data to achieve a desired tradeoff between two or more image quality metrics, such as radiation dosage and scan interval. In one embodiment, for example, the system 200 performs a preliminary scan for about 20 or about 50 percent of the total scan interval for acquiring sufficient imaging data for subsequent analysis and image reconstruction.

Particularly, in certain embodiments, the system 200 employs rapid scanning protocols during the preliminary scan to allow acquisition of coincidence data for generating a complete ROI image. Alternatively, the system 200 employs a specialized imaging system such as a SPECT system employing General Electric Company's Alcyone™ technology to acquire projection data from various view angles for reconstructing a first ROI image. The preliminary scan, thus, allows reconstruction of the first image of the target ROI using the projection data (preliminary projection data) acquired over a first fraction of the designated scan interval at step 304, while allowing use of the remaining scan interval for improving imaging performance around the target ROI.

In one embodiment, the first image allows for identification of the target ROI, for example, indicative of an anomaly such as a lesion or nodule. To that end, the system 200 displays the preliminary projection data and/or one or more corresponding images on the output device 226 for evaluation by a PET system operator. The operator analyzes the preliminary projection data and/or corresponding reconstructed images to identify the target ROI from the acquired preliminary projection data. Specifically, in one example, the operator reviews the preliminary projection data indicative of regions of increased activity concentration as compared to surrounding tissues to identify the target ROI using a GUI.

Alternatively, the system 200 employs previously available medical information, such as a previously performed computed tomography (CT) scan data to identify the approximate position of the target ROI. In certain embodiments, the system 200 employs computer aided evaluation, automated tools and/or applications for identifying the target ROI. The automated tools, for example, use one or more techniques such as segmentation or identifying specific signatures of the structures using matched filters for identifying the target ROI. In certain embodiments, the target ROI is identified based on certain structural anomalies such as lesions or nodules detected during previous examinations.

Further, at step 306, the system 200 uses projection data (further projection data) acquired over a second fraction of the designated scan interval, for example a further 25 percent of the total scan interval, for reconstructing a second image of the target ROI. To that end, the system 200 communicates the further projection data to the image reconstruction unit 224. The image reconstruction unit 224 uses at least a subset of the further projection data and/or the preliminary projection data to reconstruct a second image of the target ROI. Particularly, in one embodiment, the image reconstruction unit 224 reconstructs the second image using two-thirds of the projection data acquired over the designated scan interval. To that end, in one embodiment, a subset of the radiation events is selected randomly, for example, by selecting two out of three of the projection data sets or radiation events acquired during the first and/or second fraction of the designated scan interval.

Further, at step 308, the system 200 determines a change in an image quality characteristic, such as noise, over different fractions of the designated scan interval by determining one or more differences between the first image and the second image. In one embodiment, the system 200 estimates noise, for example, using equation 1 presented herein.

$$noise = \sqrt{\frac{2}{n} \sum \frac{{( {V}_{1 i} - {V}_{2 i} )}^{2}}{( {V}_{1 i} + {V}_{2 i} )}} \qquad ( Equation 1 )$$

In Equation 1, “V₁ᵢ” corresponds to the i^{th} voxel in the first dataset, “V₂ᵢ” is representative of the corresponding voxel in the second dataset and “n” corresponds to the number of voxels in the volume of interest. Voxels, in this context, may be either individual voxels in the reconstructed image, or reformatted volumes of interest, for example, regions corresponding to individual sectors of the heart for which perfusion parameters are computed using a conventional “bullseye” method.

Particularly, in the embodiment using equation 1, the system 200 estimates the voxel-by-voxel difference between the first and second images using voxel-by-voxel subtraction to determine the difference. The difference is squared and the squared value is then divided by the mean of corresponding voxels in the two image datasets. The sum of the resulting dividend is taken over all the voxels in a given ROI. This sum is then divided by the number of voxels in the ROI to provide an estimation of the noise in the images.

In one embodiment, the estimated noise varies with square root of the scan interval. In an alternative embodiment, however, the variations in image noise depend upon other imaging parameters such as the type of image reconstruction used. Accordingly, in certain embodiments, the system 200 generates a noise versus time curve to predict expected changes in noise values over increasing scan intervals. Particularly, in one embodiment, the system 200 generates the noise versus time curve by computing the noise parameter using equation 1. To that end, the system 200 employs bootstrapped datasets that represent different fractions of the imaging data acquired thus far.

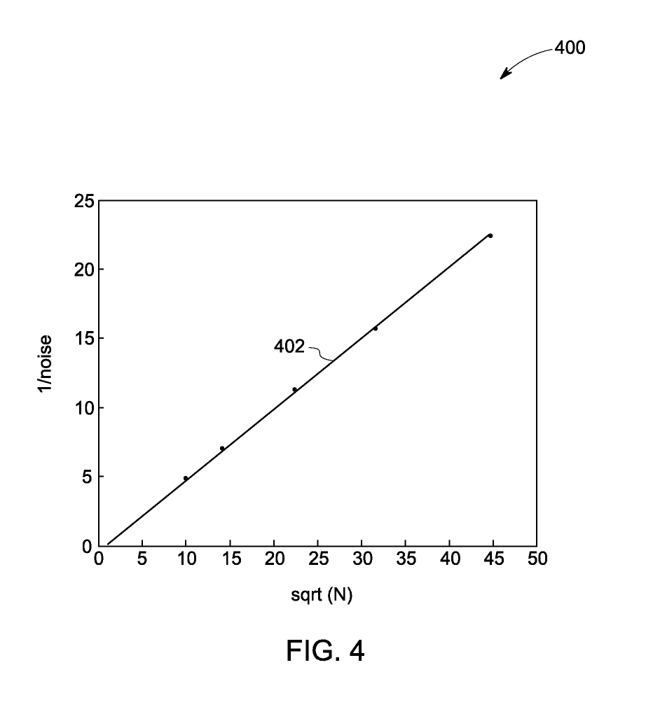

FIG. 4, for example, shows a graphical representation 400 of a noise versus time curve 402 generated by computing the noise parameter corresponding to imaging data obtained for different acquisition times using equation 1. Particularly, in one embodiment, in which the system 200 plots the inverse of the estimated noise, for example, against the square root of time, the resulting noise versus time curve 402 corresponds to a straight line. Computing a few points of this line allows the system 200 to estimate an appropriate imaging parameter, such as a scan duration that would lead to a reconstruction of an image having at least a predetermined level or value of an image quality characteristic, for example, a designated noise level or a designated lesion detectability.

For certain types of reconstruction algorithms, a relationship between noise and time, however, may follow a different curve. In such scenarios, the system 200 determines the noise versus time relationship by performing a few bootstrapped reconstructions. The system 200 then uses the determined relationship to extrapolate the data and estimate an appropriate amount of acquisition time needed for a scan of a designated quality, for example, suited for a particular medical examination.

To that end, in one embodiment, the system 200 generates two or more bootstrapped data sets, for example of about 2.5 minutes each, via random selection from the projection data acquired over the designated scan interval, for example, of about five minutes. Each data set is used as an individual measurement to determine a statistical distribution of an estimated image quality characteristic, for example, noise, the SUV or a degree of ischemia of heart tissues. In one embodiment, the determined statistical distribution is indicative of the uncertainty in the ROI of the reconstructed images. In certain embodiments, the system 200 determines a variance in the value of the image quality characteristic over increasing scan durations using the bootstrap data sets generated from a fraction of the original projection data.

Further, at step 310 in FIG. 3, the system 200 estimates value of an imaging parameter, such as a total or remaining scan interval for use in acquiring sufficient projection data for generating an image of the target ROI having desired image quality characteristics. To that end, in one embodiment, the system 200 uses the variance in the image quality characteristic determined using the bootstrap data sets as a good approximation of the variance or change in value of the image quality characteristic typically determined using the entire projection data acquired over the designated scan interval.

Particularly, determining the change in the value of the image quality characteristic such as image noise, contrast, SNR and lesion detectability allows ascertaining the improvement in uncertainty in an image reconstructed with additional image statistics. The ascertained improvement, in turn allows estimation of additional acquisition time needed in order to drive the uncertainty of the image quality characteristic below a designated threshold.

Further, in certain embodiments, the system 200 provides a visual indication of the estimated improvement in uncertainty with additional image statistics to the output device 226 such as a display associated with the operator workstation 228. Communicating the estimated improvement in uncertainty with additional image statistics allows the operator to make an informed tradeoff between quality of the clinical information derived from the images reconstructed with the projection data acquired so far, and use of additional imaging time while the acquisition is still in progress and the patient is still on the table.

The embodiment illustrated in FIG. 3, thus, describes a nuclear imaging technique for improving image data acquisition by accurately estimating variations in image quality characteristics over different scan durations using the bootstrap approach. The operator can use the estimated variations in image quality over time to determine when and whether to continue or terminate a scan. However, it may be noted, that the embodiments of present method may also be applicable to estimate suitable values of other statistical parameters such as contrast recovery or CNR estimation using a bootstrap approach, for example, with synthetic lesions to improve image quantitation.

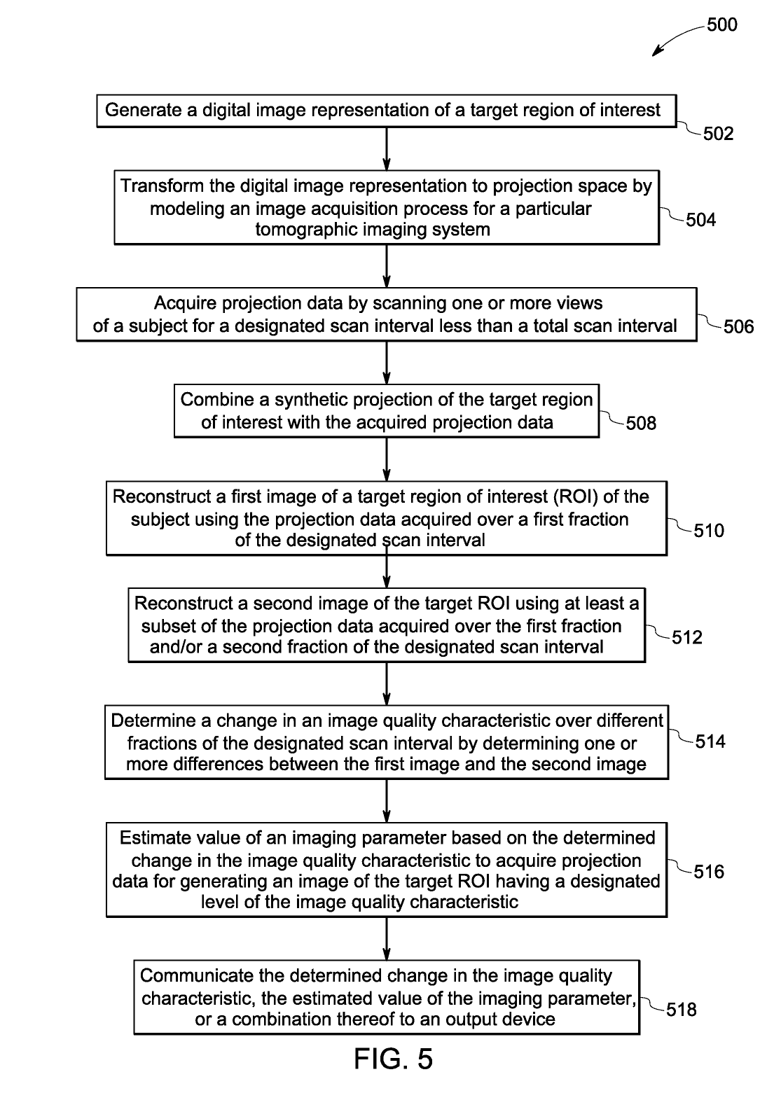

FIG. 5 illustrates a flow chart 500 depicting an exemplary tomographic imaging method that uses synthetic lesions in addition to the bootstrap reconstruction technique. Embodiments of the method will be described, for example, with reference to tomographic imaging of a target ROI such as a patient's lung or liver using system 200 to detect location of a lesion for which no or limited prior information may be available. Accordingly, at step 502, the system 200 generates a digital image representation of a lesion, for example, using known properties like lesion size and source-to-background activity ratio. At step 504, the system 200 transforms the digital image representation to projection space by modeling the image acquisition process for the system 200.

Additionally, at step 506, the system 200 acquires projection data by scanning one or more views of a subject for a designated scan interval, where the designated scan interval is less than a total scan interval. Further, at step 508, the system 200 combines a synthetic projection of the lesion with the acquired projection data. At step 510, the system 200 reconstructs a first image of the lesion using projection data acquired over a first fraction of the designated scan interval. Furthermore, at step 512, the system 200 reconstructs a second image of the lesion using at least a subset of projection data acquired over the first and a second fraction of the designated scan interval.

The system 200, at step 514, determines a change in an image quality characteristic, such as lesion contrast, over the first and the second fractions of the designated scan interval by determining one or more differences between the first image and the second image. The differences, for example, between the reconstructed lesion contrast and the true simulated lesion contrast provides a measure of the bias in the lesion quantitation. At step 516, the system 200 estimates a value of an imaging parameter such as acquisition time based on the change in the lesion contrast over the first and the second fractions of the designated scan interval.

In certain embodiments, the system 200, at step 518, communicates the change in the image quality characteristic or the estimated value of the imaging parameter to an output device. Communicating the values estimated by using synthetic lesions in combination with the embodiment of the bootstrap technique presented herein provides a PET system operator with information about the bias and the variance in the measurement, for example, of the SUV of a lesion of known size and activity.

Knowing the bias and variance information provide the operator a confidence limit for the largest lesion that cannot be detected with the given image statistics. Particularly, for applications like therapy response monitoring, the bias and variance information determined using the bootstrap technique can be used to modulate an image quality characteristic such as the acquisition time to measure a change in the SUV of the lesion with a particular statistical confidence level, thus alleviating uncertainty in reconstructed images.

Although specific features of various embodiments of the invention may be shown in and/or described with respect to only certain drawings and not in others, this is for convenience only. It is to be understood that the described features, structures, and/or characteristics may be combined and/or used interchangeably in any suitable manner in the various embodiments, for example, to construct additional assemblies and techniques. Furthermore, the foregoing examples, demonstrations, and process steps, for example, those that may be performed by the processing unit 222, the gantry controller 114, the DAS 208 and the image reconstruction unit 224 may be implemented by suitable code on a processor-based system.

It should also be noted that different implementations of the present technique may perform some or all of the steps described herein in different orders or substantially concurrently, that is, in parallel. In addition, the functions may be implemented in a variety of programming languages, including but not limited to Python, C++ or Java. Such code may be stored or adapted for storage on one or more tangible, machine-readable media, such as on data repository chips, local or remote hard disks, optical disks (that is, CDs or DVDs), solid-state drives or other media, which may be accessed by a processor-based system to execute the stored code.

While only certain features of the present invention have been illustrated and described herein, many modifications and changes will occur to those skilled in the art. It is, therefore, to be understood that the appended claims are intended to cover all such modifications and changes as fall within the true spirit of the invention.

1. A method for tomographic imaging, comprising:
acquiring projection data by scanning one or more views of a subject for a designated scan interval, wherein the designated scan interval is less than a total scan interval;
reconstructing a first image of a target region of interest of the subject using projection data acquired over a first fraction of the designated scan interval;
reconstructing a second image of the target region of interest using at least a subset of projection data acquired over the first fraction of the designated scan interval, a second fraction of the designated scan interval, or a combination thereof;
determining a change in an image quality characteristic over the first and the second fractions of the designated scan interval by determining one or more differences between the first image and the second image; and
estimating a value of an imaging parameter based on the change in the image quality characteristic over the first and the second fractions of the designated scan interval to acquire projection data for generating an image of the target region of interest having at least a predetermined level of the image quality characteristic.

2. The method of claim 1, further comprising communicating the estimated value of the imaging parameter to an output device.

3. The method of claim 2, further comprising continuing a tomographic scan of the subject when an image of the target region of interest reconstructed using the estimated value of the imaging parameter does not meet the predetermined level of the image quality characteristic.

4. The method of claim 2, further comprising terminating a tomographic scan of the subject when an image of the target region of interest reconstructed using the estimated value of the imaging parameter meets the predetermined level of the image quality characteristic.

5. The method of claim 1, further comprising communicating the projection data, the first image, the second image, the change in the image quality characteristic over the first and the second fractions of the designated scan interval, or combinations thereof, to an output device.

6. The method of claim 1, comprising using the subset of the projection data acquired over the first fraction of the designated scan interval and the second fraction of the designated scan interval for reconstructing the second image of the target region of interest.

7. The method of claim 1, wherein determining the one or more differences between the first image and the second image comprises using root mean squared difference of pairs of corresponding voxels in the first image and the second image.

8. The method of claim 1, wherein estimating the value of the imaging parameter comprises estimating the total scan interval, a remaining scan interval, a view angle, a count of detected radiation events, or combinations thereof, and wherein the projection data for generating the image of the target region of interest having at least the predetermined level of the image quality characteristic is acquired using the estimated value of the imaging parameter.

9. The method of claim 1, wherein the image quality characteristic comprises spatial resolution, signal energy, signal-to-noise ratio, contrast-to-noise ratio, contrast recovery, lesion bias, detectability, or combinations thereof.

10. A non-transitory computer readable medium that stores instructions executable by one or more processors to perform a method for tomographic imaging, comprising:
acquiring projection data by scanning one or more views of a subject for a designated scan interval, wherein the designated scan interval is less than a total scan interval;
reconstructing a first image of a target region of interest of the subject using projection data acquired over a first fraction of the designated scan interval;
reconstructing a second image of the target region of interest using at least a subset of projection data acquired over the first fraction of the designated scan interval, a second fraction of the designated scan interval, or a combination thereof;
determining a change in an image quality characteristic over the first and the second fractions of the designated scan interval by determining one or more differences between the first image and the second image; and
estimating value of an imaging parameter based on the change in the image quality characteristic over the first and the second fractions of the designated scan interval to acquire projection data for generating an image of the target region of interest having at least a predetermined level of the image quality characteristic.

11. An nuclear medicine imaging system, comprising:
one or more detectors configured to acquire projection data from one or more views corresponding to a subject during different fractions of a designated scan interval, wherein the designated scan interval is less than a total scan interval; and
an image reconstruction unit configured to reconstruct two or more images of a target region of interest of the subject using at least a subset of projection data selected from projection data acquired over different fractions of the designated scan interval in response to one or more control signals;
a processing unit coupled to one or more of the detectors and the image reconstruction unit, wherein the processing unit:
provides one or more of the control signals to one or more of the detecors to acquire projection data by scanning one or more views of the subject for the designated scan interval;
provides one or more of the control signals to the image reconstruction unit for reconstructing a first image of a target region of interest of the subject using projection data acquired over a first fraction of the designated scan interval;
provides one or more of the control signals to the image reconstruction unit for reconstructing a second image of the target region of interest using projection data acquired over a first fraction of the designated scan interval, a second fraction of the designated scan interval, or a combination thereof;
determines a change in an image quality characteristic over the first and the second fractions of the designated scan interval by determining one or more differences between the first image and the second image; and
estimates value of an imaging parameter based on the estimated change in the image quality characteristic over the first and the second fractions of the designated scan interval to acquire projection data for generating an image of the target region of interest having at least a predetermined level of the image quality characteristic.

12. The nuclear medicine imaging system of claim 13, wherein the imaging system comprises a single or multiple detector imaging system, a positron emission tomography (PET) scanner, a single photon emission computed tomography (SPECT) scanner, a dual head coincidence imaging system, or combinations thereof.

13. A method for tomographic imaging, comprising:
generating a digital image representation of a target region of interest;
transforming the digital image representation to projection space by modeling an image acquisition process for a particular tomographic imaging system;
acquiring projection data by scanning one or more views of a subject for a designated scan interval, wherein the designated scan interval is less than a total scan interval;
combining a synthetic projection of the target region of interest with the acquired projection data;
reconstructing a first image of the target region of interest using projection data acquired over a first fraction of the designated scan interval;
reconstructing a second image of the target region of interest using at least a subset of projection data acquired over the first fraction of the designated scan interval, a second fraction of the designated scan interval, or a combination thereof;
determining a change in an image quality characteristic over the first and the second fractions of the designated scan interval by determining one or more differences between the first image and the second image; and
estimating value of an imaging parameter based on the determined change in the image quality characteristic over the first and the second fractions of the designated scan interval.

14. The method of claim 13, further comprising communicating the change in the image quality characteristic, the estimated value of the imaging parameter, or a combination thereof to an output device.

15. The method of claim 13, wherein the target region of interest comprises a lesion or a nodule.

16. The method of claim 15, comprising using a known lesion size, source-to-background activity ratio, or a combination thereof, for generating the digital image representation of a target region of interest.

17. The method of claim 15, wherein determining one or more differences between the first image and the second image comprises determining a difference between a reconstructed lesion contrast and a true simulated lesion contrast.

18. The method of claim 17, wherein determining the one or more differences between the reconstructed lesion contrast and the true simulated lesion contrast provides a measure of a bias in lesion quantitation.

19. The method of claim 18, further comprising acquiring projection data using the estimated value of the imaging parameter for generating an image of the target region of interest having at least the predetermined level of the image quality characteristic if the bias in lesion quantitation is outside a designated threshold.

20. The method of claim 18, further comprising terminating a tomographic scan of the subject when the bias in lesion quantitation is within a designated threshold.
